(19) United States
(12) Patent Application Publication
(10) Pub. No.: US 2002/0047783 A1
(43) Pub. Date: Apr. 25, 2002

(54) Vertical sump alarm

(76) Inventors: Alan J. Bergum, Detroit Lakes, MN (US); Mark B. Baumgartner, Detroit Lakes, MN (US); Rory G. Lee, Detroit Lakes, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 09/933,358

(22) Filed: Aug. 20, 2001

Related U.S. Application Data
(63) Continuation-in-part of application No. 09/545,811, filed on Apr. 7, 2000.
Application No. 09/545,811 is a continuation-in-part of application No. 09/272,438, filed on Mar. 19, 1999.

(51) Int. Cl. G08B 21/00

(52) U.S. Cl. 340/618; 340/612

(57) ABSTRACT

A sump alarm system which includes a sensor, carried by a sensor housing, the sensor being operatively connected to an alarm circuit, carried in an alarm circuit enclosure, the alarm circuit configured to output an alarm signal when the sensor senses a predetermined alarm condition.

### CROSS-REFERENCE TO RELATED APPLICATIONS

This application is a Continuation-In-Part (CIP) application of U.S. Application No. 09/545811 filed Apr. 7, 2000, which was a CIP application of U.S. Application No. 09/272,438 filed Mar. 19, 1999, which issued Oct. 31, 2000 as U.S. Pat. No. 6140925, the entire contents of each application hereby being incorporated by reference.

### STATEMENT REGARDING FEDERALLY SPONSORED RESEARCH

Not Applicable

### BACKGROUND OF THE INVENTION

1. Field of the Invention

This invention relates to a vertical sump alarm, and in particular to a sump alarm having a two-piece construction with an alarm sensor conductively connected to alarm circuitry.

As is well known in the art, sump pump control systems control water levels, with the control apparatus turning on the pump at a predetermined upper water level and pumping stopping at a predetermined low water level. If the sump pump or control apparatus fails, it is important to be alerted of the failure. The invention and its various embodiments have one or more of the following advantages over existing alarm systems:

Integration of the sump control device, sensor, and alarm.

Ease of installation.

Early warning of sump pump failure.

Wall mounting the alarm device protects the circuitry from water damage.

Lower cost than purchasing sump control device and alarm separately.

Flexibility to use the same sensor and alarm device for the stand alone

system, the system mounted to sump control device or the system integrated into the sump control device housing.

What is needed is an alarm which is inexpensive and which will not be damaged by high water, but still provide an early warning of a high water state.

### BRIEF SUMMARY OF THE INVENTION

Applicant has solved the problems identified above by providing a two part sump alarm system consisting of an alarm sensor portion and an alarm circuit portion. The alarm sensor portion is mounted such that at the desired water level the sensor will trigger the high water alarm. The alarm sensor can be mounted to a sump pump control device; integrated into a sump pump control device or attached to any other convenient mounting surface, such as a discharge tube. The sensor is conductively connected to the alarm circuit portion, which is placed in a position such that the high water state will not damage the alarm circuitry. The alarm circuit portion can be mounted to any convenient surface or in one embodiment, attached to a piggyback plug.

### BRIEF DESCRIPTION OF THE SEVERAL VIEWS OF THE DRAWINGS

A detailed description of the invention is hereafter described with specific reference being made to the drawings in which:

FIG. 1 is a block diagram of the inventive sump alarm;

FIG. 2 is a block diagram of an embodiment of the inventive alarm sensor portion of the inventive sump alarm;

FIG. 3 is a block diagram of an embodiment of the inventive alarm circuitry portion of the inventive sump alarm;

FIG. 4 is a front view showing the alarm circuitry enclosure connected to the alarm sensor housing;

FIG. 5 is a perspective view showing the alarm sensor mounted to a sump pump control apparatus;

FIG. 6 is a perspective view showing a piggyback plug with molded dovetail for attaching the alarm circuitry enclosure of FIG. 7;

FIG. 7 is a perspective view of an embodiment of the alarm circuitry enclosure with molded dovetail for attaching to the piggyback plug of FIG. 6;

FIG. 8 is a perspective view of the alarm circuitry enclosure of FIG. 7 attached to the piggyback plug of FIG. 6;

FIG. 9 is a perspective view showing how the alarm sensor housing mounts to the sump pump control apparatus;

FIG. 10 is an exploded perspective view of the components of the sensor alarm;

FIG. 11 shows the alarm sensor housing mounted to a discharge tube;

FIG. 12 is an exploded perspective view of the device of FIG. 11;

FIG. 13 shows the alarm circuit housing of FIG. 4 in more detail;

FIG. 14 shows the stop ribs discussed in connection with FIG. 10 in more detail, and FIG. 15 shows a schematic diagram of a capacitive or conductive probe embodiment of the invention.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

FIG. 1 shows the inventive sump alarm generally at 10, which consists of an alarm sensor 12 conductively connected to alarm circuitry 14.

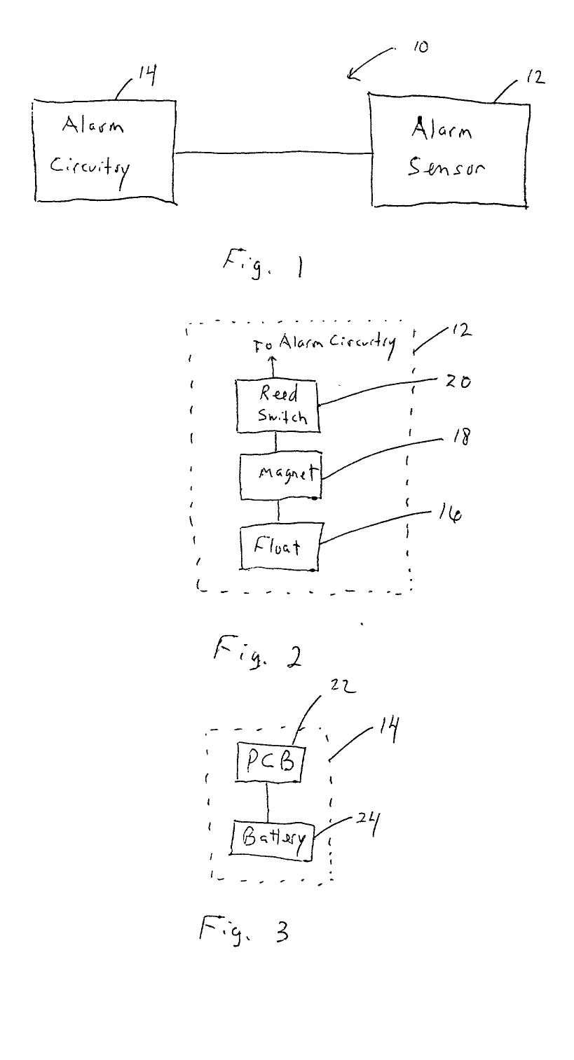

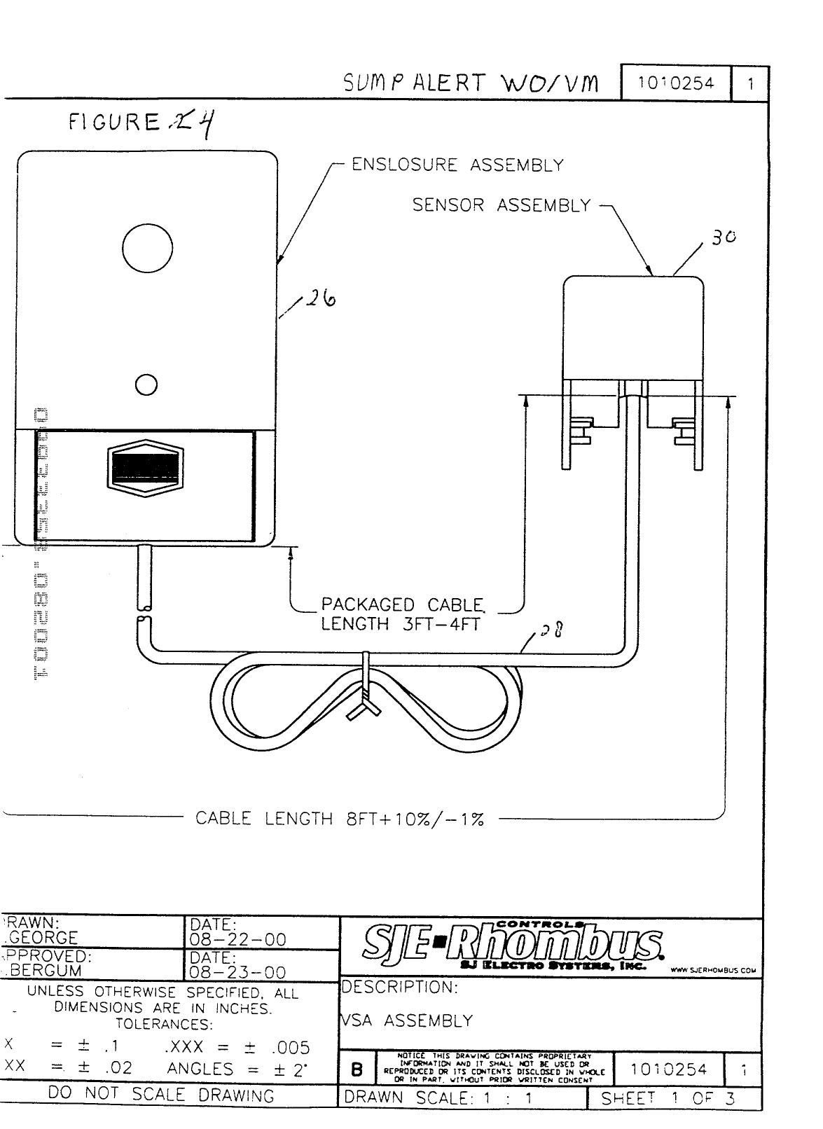

FIG. 2 shows an embodiment of the alarm sensor 12 in which in a high water alarm state, a float 16, which carries a magnet 18, will be lifted so that reed switch 20 will close a circuit, the reed switch being conductively connected to the alarm circuitry 14 with 2 conductors. When the circuit is closed the alarm will sound. Reed switches activated by a magnet are well known in the art. Although the inventive is described in connection with a reed switch which closes a circuit when in the high water alarm state, any existing alarm sensor could be utilized which has a voltage change to indicate a condition, such as a diaphragm sensor, conductive probes or a microswitch.

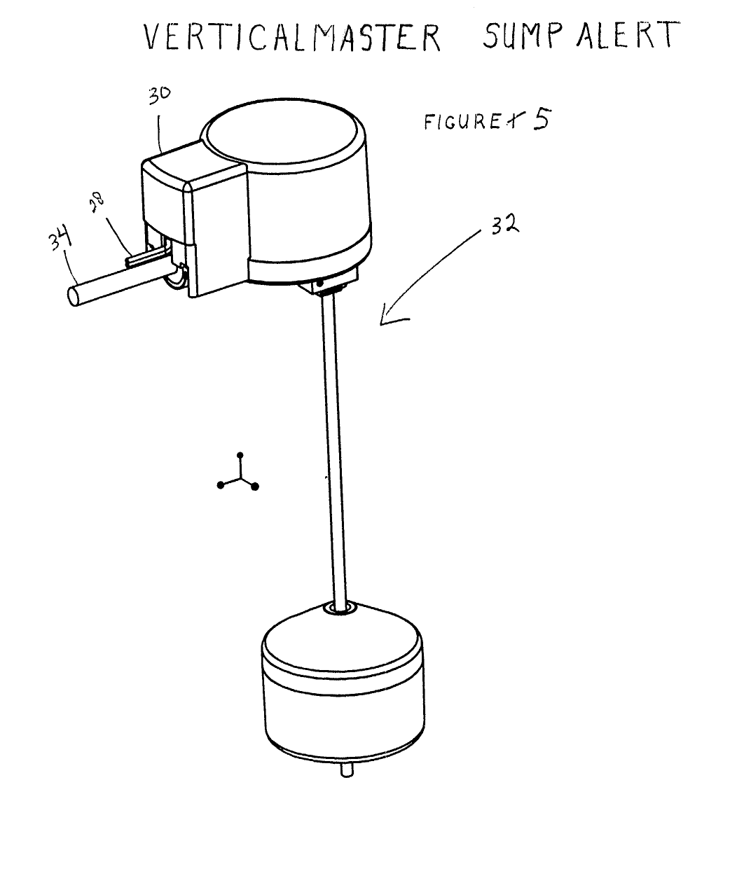

FIG. 3 shows an embodiment of the alarm circuitry 14 in which the alarm circuitry is carried on a printed circuit board (PCB) 22 which is powered by a battery 24. In the preferred embodiment, the voltage drop caused by the magnet triggering the reed switch to close the circuit is utilized to indicate the high water alarm condition. It should be understood that the alarm circuit could easily be configured to sense a continuous condition and provide a signal only which the condition exists, or to provide a signal only if the condition exists momentarily.

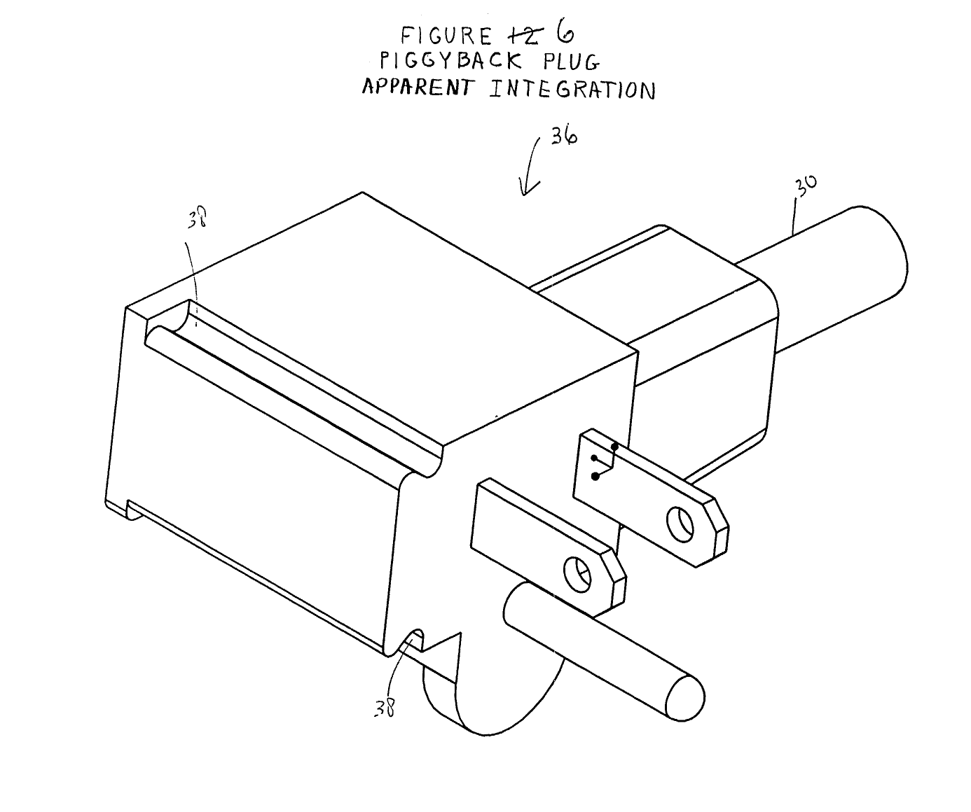

FIG. 4 shows an embodiment of the alarm circuitry enclosure 26 connected by 2 conductor wire 28 to the alarm sensor housing 30. The alarm circuitry is configured to emit a chirping sound when in the alarm condition and can also be configured to illuminate a light in the alarm condition. The alarm circuitry is also configured with a battery test circuit and/or to emit a chirping sound when the battery is low.

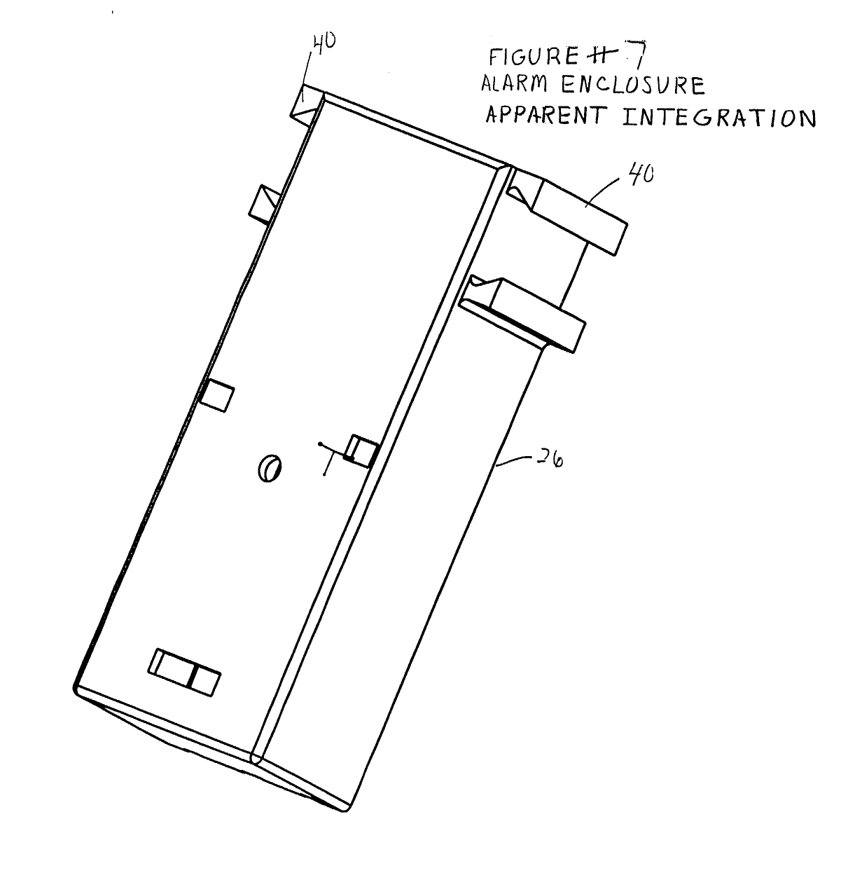

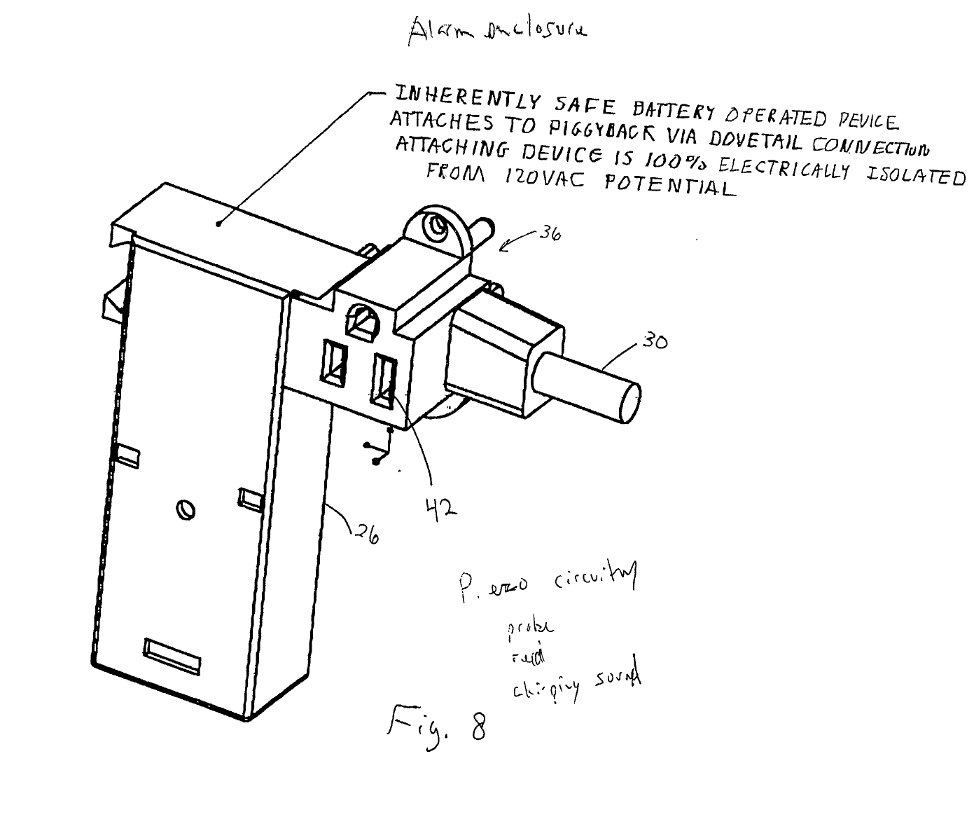

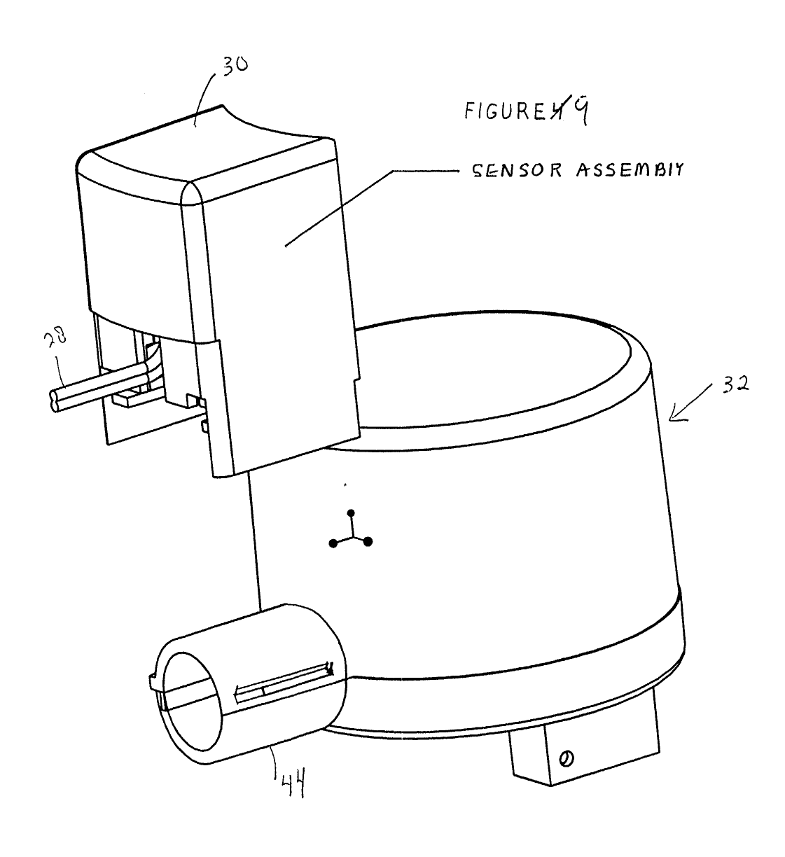

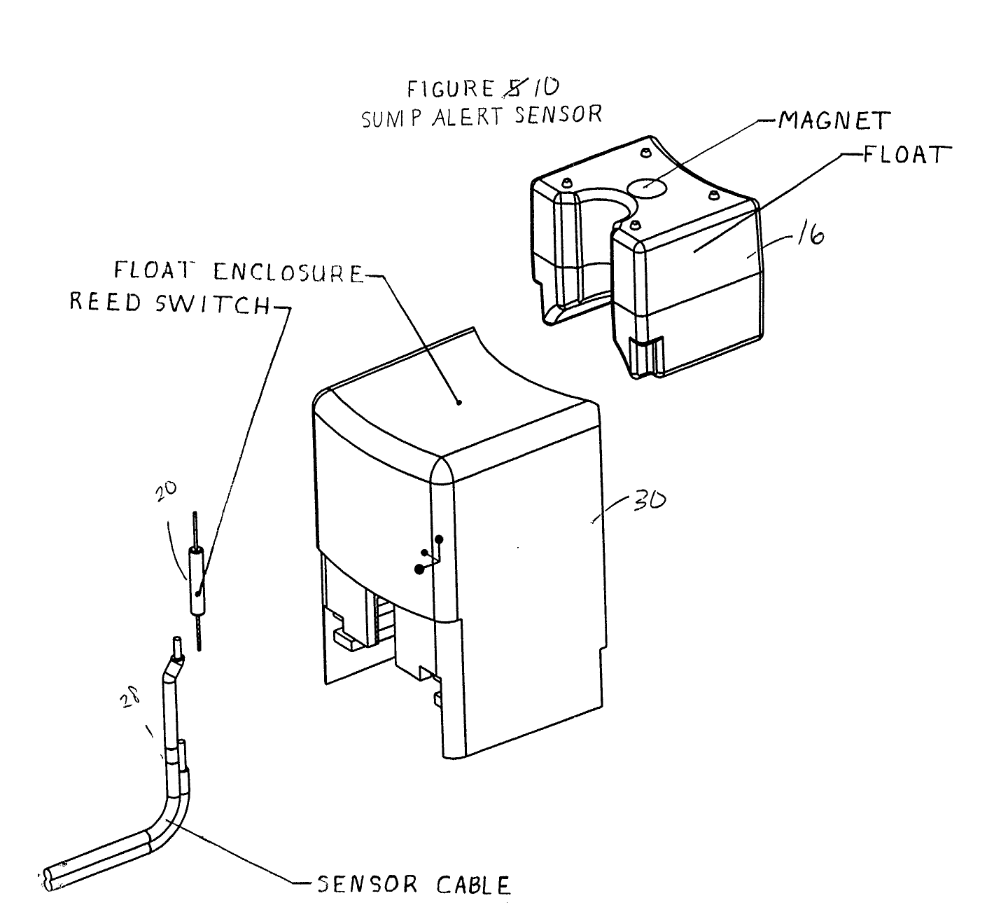

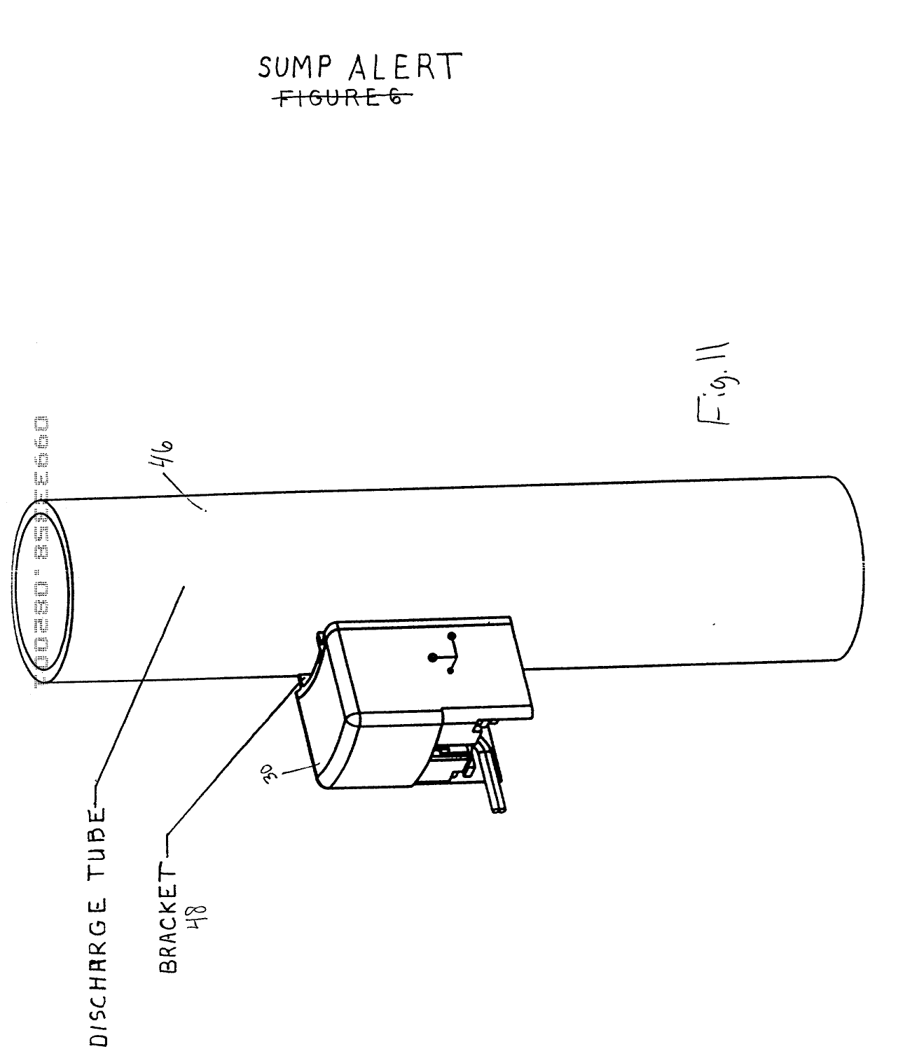

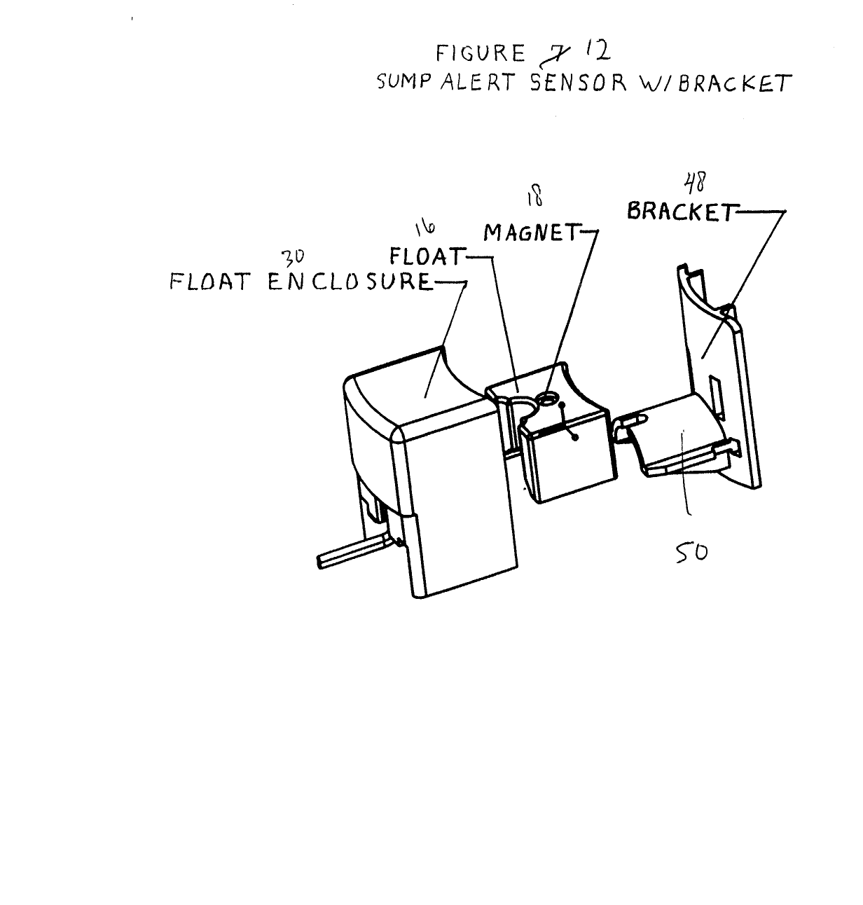

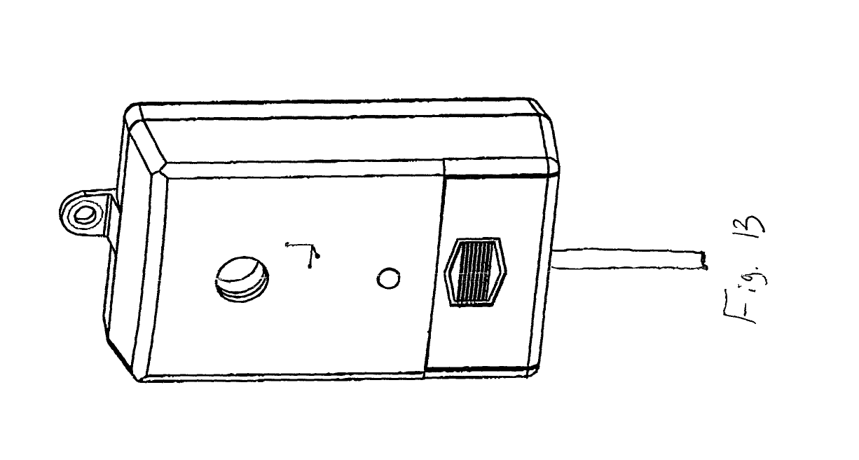

Referring now to FIGS. 5-8, FIG. 5 shows the alarm sensor housing 30 mounted to a sump pump control apparatus shown generally at 32. Sump pump control apparatus 32 can be any existing type of sump pump control apparatus, and applicants existing sump pump control apparatus is described in greater detail in U.S. Pat. No. 6140925 which issued Oct. 31, 2000. Two-conductor wire 28 is connected to the alarm circuitry 14. Supply cord 34 is connected to the pump (not shown). In the preferred embodiment supply cord 34 is connected using applicants inventive improved electrical connection technique, as described in copending parent application no. 09/545811 filed Apr. 7, 2000. Supply cord 30 is plugged into piggyback plug 36, shown in FIG. 6. Piggyback plug 36 is molded at 38 to slidably receive the alarm enclosure of FIG. 7, which has mating molded portions 40 which allow the alarm enclosure to slide onto piggyback plug 36 from either side. FIG. 8 shows the assembly of the enclosure 26 slid onto piggyback plug 36 which in turn can plug into a wall outlet (not shown) and still provide a pass-through outlet 42, or 42 could be used to plug in the pump, if the improved electrical connector of 09/545811 is not utilized.

FIG. 9 shows how alarm sensor housing 30 mounts around portion 44 of sump pump control apparatus 32. However, it should be understood that the alarm sensor housing may also be mounted to a discharge tube, or other convenient surface (see FIG. 11).

FIG. 10 shows the components of an embodiment of the sensor alarm 12, in which the float is shown at 16, which is molded to fit inside housing 30. The walls of the housing 30 guide float 16. The inside cover of the housing 30 defines the upper vertical stop and the lower vertical stop of float 16 is defined by the ribs 31 inside housing 30 (best seen in FIG. 14). Float 16 carries magnet 18. Float 16 with magnet 18 aligns with the reed switch 20 to close the contacts in reed switch 20 once it has achieved the optimized distance from the reeds, as is well known in the art. The magnetically actuated reed switch triggers the alarm when the contacts are closed, which is determined by the alarm circuitry 14 using the two conductors 28, each of which are attached on either side of the reed switch, as is well known in the art. As is well known in the art, reed switch 20 consists of magnetically attracted reeds with contacts sealed in glass and surrounded by an inert gas. The gas insures that low battery currents are not impeded by oxidation or worn down by arching loads associated with alarm circuit components.

FIG. 11 shows the alarm sensor housing 30 mounted to a discharge tube 46 with bracket 48. FIG. 11 is for an embodiment of the sump alarm which is stand-alone or not attached directly to the sump pump control apparatus. Alarm sensor housing 30 is mounted to discharge tube at the appropriate height to trigger a high water alarm at the desired water level.

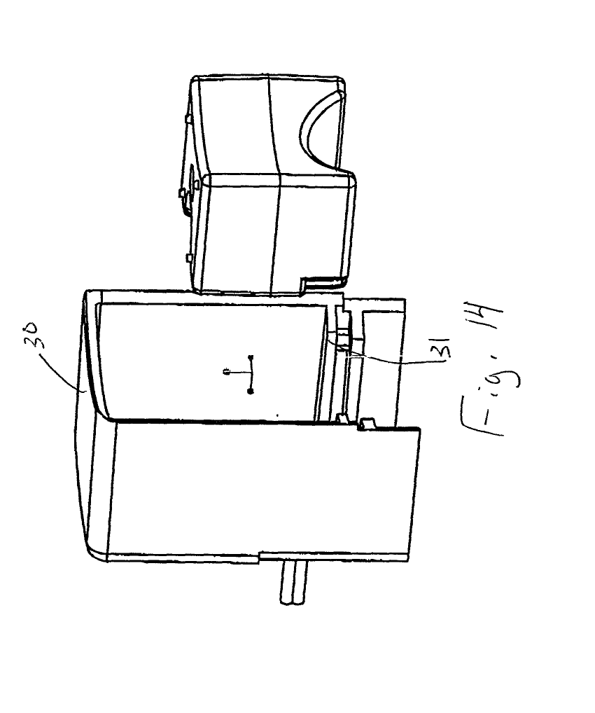

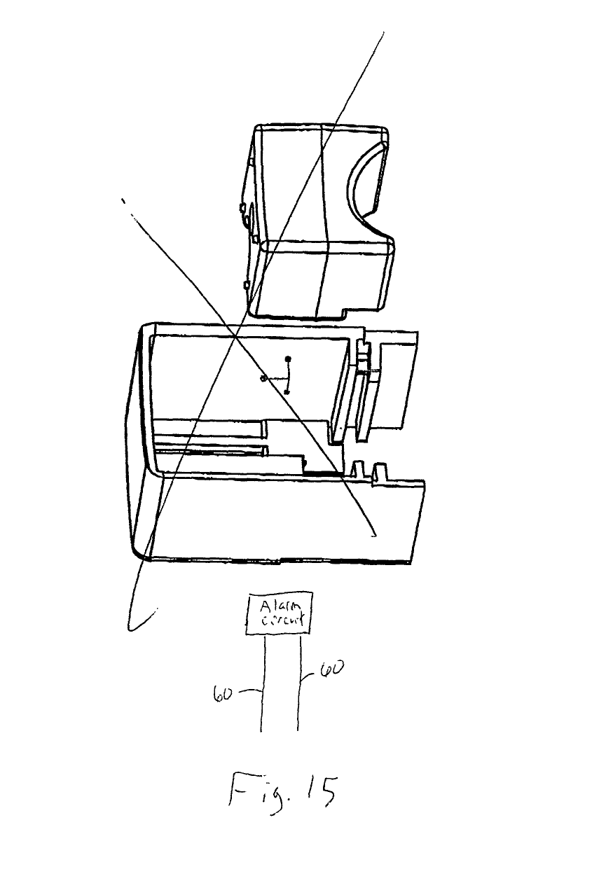

FIG. 12 shows an exploded view of the sensor alarm and bracket 48 for attaching the sensor alarm to the discharge tube 46. As shown in FIG. 14, and discussed above, ribs 31 form the lower float stop.

FIG. 15 shows a schematic diagram of a capacitive or conductive probe version of the alarm sensor housing of FIG. 11, in which two capacitive or conductive probe elements 60 extend below the housing 30. The bottom ends of elements 60 are positioned such that when the fluid, such as water in a sump cover the lower ends, a short circuit is created which activates the alarm circuit. As is well known in the art, in a capacitive probe capacitance is measured and in a conductive probe, resistance is measured. It should also be understood that the capacitive or conductive probe embodiment of FIG. 15 could also be incorporated directly into the sump control device.

The above examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

1. A sump alarm system comprising:
a sensor, carried by a sensor housing, the sensor being operatively connected to an alarm circuit, carried in an alarm circuit enclosure, the alarm circuit configured to output an alarm signal when the sensor senses a predetermined alarm condition;
the alarm sensor housing being constructed and arranged to matingly mount to a sump pump control device.

2. The sump alarm system of claim 1 wherein the predetermined alarm condition is a high water level.

3. The sump alarm system of claim 1 wherein the alarm circuit includes an audible alarm which is operatively connected to the output signal of the alarm circuit.

4. The sump alarm system of claim 1 wherein the alarm circuit includes a visual alarm which is operatively connected to the output signal of the alarm circuit.

5. The sump alarm system of claim 1 wherein the sensor includes a magnetically actuated reed switch.

6. The sump alarm system of claim 1 wherein the sensor includes at least one conductive probe.

7. The sump alarm system of claim 1 wherein the sensor includes at least one capacitive probe.

8. The sump alarm system of claim 1 wherein the sensor includes a switch.

9. The sump alarm system of claim 1 wherein the alarm circuit enclosure is constructed and arranged to matingly mount to a piggyback plug.

10. The sump alarm system of claim 9 wherein the sump pump control device is a magnetically actuated float switch.

11. A sump alarm system comprising:
a sump pump control device, the sump pump control device including a sensor, the sensor being operatively connected to an alarm circuit, the alarm circuit configured to output an alarm signal when the sensor senses a predetermined alarm condition.

12. A sump alarm system comprising:
a sump pump control device, the sump pump control device including a sensor, the sensor being operatively connected to an alarm circuit, the alarm circuit configured to output an alarm signal when the sensor senses a predetermined alarm condition, the alarm circuit further being selected from the group consisting of a capacitive probe and a conductive probe, the alarm circuit having two probe elements which extend from the sump pump control device such that when the fluid is at a predetermined height the two probe elements extend into the water to activate the alarm circuit.

13. A sump alarm system comprising:
a sensor, carried by a sensor housing, the sensor being operatively connected to an alarm circuit, carried in an alarm circuit enclosure, the alarm circuit configured to output an alarm signal when the sensor senses a predetermined alarm condition;
the alarm sensor housing being constructed and arranged to matingly mount to a surface selected from the group consisting of a discharge tube and a sump pump basin.

14. A sump alarm system comprising:
a sensor, carried by a sensor housing, the sensor being operatively connected to an alarm circuit, carried in an alarm circuit enclosure, the alarm circuit configured to output an alarm signal when the sensor senses a predetermined alarm condition;
the alarm circuit enclosure being constructed and arranged to matingly mount to a piggyback plug.

15. The sump alarm system of claim 13 wherein the predetermined alarm condition is a high water level.

16. The sump alarm system of claim 13 wherein the alarm circuit includes an audible alarm which is operatively connected to the output signal of the alarm circuit.

17. The sump alarm system of claim 13 wherein the alarm circuit includes a visual alarm which is operatively connected to the output signal of the alarm circuit.

18. The sump alarm system of claim 13 wherein the sensor includes a magnetically actuated reed switch.

19. The sump alarm system of claim 13 wherein the sensor includes at least one conductive probe.

20. The sump alarm system of claim 13 wherein the sensor includes at least one capacitive probe.

21. The sump alarm system of claim 13 wherein the sensor includes a switch.

22. The sump alarm system of claim 13 wherein the alarm sensor housing is constructed and arranged to matingly mount to a sump pump control device.

23. The sump alarm system of claim 22 wherein the sump pump control device is a magnetically actuated float switch.
